(19) United States
(12) Patent Application Publication
(10) Pub. No.: US 2024/0070508 A1
(43) Pub. Date: Feb. 29, 2024

(54) QUANTUM VARIATIONAL NETWORK CLASSIFIER

(71) Applicant: International Business Machines Corporation, Amonk, NY (US)

(72) Inventors: Jae-Eun Park, Wappingers Falls, NY (US); Abhijit Mitra, The Woodlands, TX (US); Vladimir Rastunkov, Mundelein, IL (US); Vaibhaw Kumar, Frederick, MD (US); Dimitrios Alevras, West Chester, PA (US)

(21) Appl. No.: 17/894,640

(22) Filed: Aug. 24, 2022

(51) Int. Cl. G06N 10/40; G06N 20/10

(52) U.S. Cl. CPC G06N 10/40; G06N 20/10

(57) ABSTRACT

A processor can control quantum hardware to transform qubit states associated with a plurality of pairs of data points in a training dataset using a circuit parameter representing a rotation angle. Inner products of transformed qubit states associated with the plurality of pairs of data points can be computed. The processor can minimize an objective function based on the inner products, where the minimizing finds a target circuit parameter representing a target rotation angle that minimizes the objective function. A processor can build a kernel matrix based on the inner products computed for a sample dataset and the target circuit parameter passed to the quantum hardware. A classification algorithm can use the kernel matrix to classify the sample dataset.

### BACKGROUND

The present application relates generally to computers and computer applications, and more particularly to quantum computers, quantum algorithms, quantum machine learning and quantum variational network for classification and/or decision boundary control.

Computers can be implemented under architecture that may include processing elements fabricated using semiconductor materials and technology, semiconductor memory devices, and magnetic or solid-state storage devices. Classical computers encode information in bits, where each bit can represent a value of 1 or 0. These 1s and 0s act as on/off switches that drive classical computer functions. If there are n bits of data, then there are 2n possible classical states, and one state is represented at a time.

Quantum computers use quantum processors that operate on data represented by quantum bits, also known as qubits. One qubit can represent the classical binary states ‘0’, ‘1’, and also additional states that are superstitions of ‘0’ and ‘1’. Due to the ability to represent superpositions of ‘0’ and ‘1’, a qubit can represent both ‘0’ and ‘1’ states at the same time. For example, if there are n bits of data, then 2n quantum states can be represented at the same time. Further, qubits in a superposition can be correlated with each other, referred to as entanglement, where the state of one qubit (whether it is a 1 or a 0 or both) can depend on the state of another qubit, and more information can be encoded within the two entangled qubits. Based on superposition and entanglement principles, qubits can enable quantum computers to perform functions that may be relatively complex and time consuming for classical computers.

A quantum support vector machine or quantum-enhanced support vector machine (also referred to as QSVM) algorithm can apply to a classification problem, which uses a feature-map implicitly specified by a kernel. In addition to kernel computation speed-up, a quantum support vector machine may provide an advantage of improved analytical performance such as improved model accuracy. However, such a kernel approach in quantum support vector machine can easily lead to overfitting and can become difficult to control in generating a proper decision boundary. Hence, a challenge remains in providing kernel functions that can be readily expressed and computed with quantum circuits, which can be useful for modeling with different types of data, as well as providing the practical application of quantum support vector machine to different datasets.

### BRIEF SUMMARY

The summary of the disclosure is given to aid understanding of a computer system and method of quantum machine learning, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.
Clause 1. A method, in an aspect, can include controlling, by at least one processor, quantum hardware to transform qubit states associated with a plurality of pairs of data points, where each pair of data points is transformed using a circuit parameter representing a rotation angle. Inner product of transformed qubit states associated with the each pair of data points can be computed. The controlling can be performed for a plurality of pairs of data points in a training dataset and inner products computed for the respective plurality of pairs of data points. The method can also include minimizing, by the at least one processor, an objective function based on the inner products, where the minimizing finds a target circuit parameter representing a target rotation angle that minimizes the objective function. The method can also include building, by the at least one processor, a kernel matrix based on the inner products computed for a sample dataset and the target circuit parameter passed to the quantum hardware.

The method of clause 1 can advantageously force the separation of data of different classes to be maximal through a rearranging, thereby facilitating ease of machine learning classification, for instance, even where a dataset initially can have a narrower separation.
Clause 2. The method clause 1 can further include performing a classification based on the kernel matrix, where the kernel matrix represents a feature map of the sample dataset. Advantageously, the method of clause 2 can use the kernel matrix that specifies a desired optimal rotation, to classify so called hard to classify mixed data with tighter decision boundaries and/or high accuracy.
Clause 3. The method of any of the previous clauses 1 to 2 can include performing classification by performing a support vector machine algorithm using the kernel matrix. Advantageously, a support vector machine can be improved in that it can use a rearranged dataset (e.g., a feature map) with maximal or optimal separation among or between classes.
Clause 4. In the methods of any of the previous clauses 1 to 3, the objective function can be defined in terms of a sum of inner products of transformed qubit states associated with the plurality of pairs of data points, and in relation to a hyperparameter. Advantageously, the objective function can find the target circuit parameter that provides for an optimum desired rotation angle that can be applied on all of the plurality of pairs of data points in quantum hardware.
Clause 5. In the methods of any of the previous clauses 1 to 4, the objective function can include the hyperparameter which is configurable. Advantageously, configurable hyperparameter allows for controlling the desired amount of distancing between the data pairs.

A system in an aspect, can include quantum hardware including at least qubits. The quantum hardware can be configured to receive signals that control the qubits to transform qubit states of the qubits. The system can also include at least one processor configured to at least control the quantum hardware to transform the qubit states associated with a pair of data points based on a circuit parameter representing a rotation angle, where inner product of transformed qubit states associated with the pair of data points can be computed. Controlling can be performed for a plurality of pairs of data points in a training dataset and inner products can be computed for respective plurality of pairs of data points. At least one processor can be further configured to minimize an objective function based on the inner products, where minimizing the objective function finds a target circuit parameter representing a target rotation angle that minimizes the objective function. At least one processor can be further configured to build a kernel matrix based on the inner products computed for a sample dataset and the target circuit parameter passed to the quantum hardware.

In an aspect, at least one processor can be further configured to perform a classification based on the kernel matrix, wherein the kernel matrix represents a feature map of the sample dataset.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a block diagram illustrating a computing environment which may facilitate quantum variational network classifier in an embodiment.

FIG. 2 is a block diagram of an example system that can provide a quantum variational network classifier and/or perform decision boundary control in an embodiment.

FIG. 3 illustrates a schematic of an example quantum computing system that may facilitate implementing a quantum variational network for classification and/or boundary decision control in an embodiment.

FIG. 4 is another diagram illustrating an example of a system that can provide for decision boundary control and/or quantum variation network classifier, e.g., in machine learning, in an embodiment.

FIG. 5 is a flow diagram illustrating a method in an embodiment.

FIG. 6 is a diagram illustrating is another diagram illustrating an example of a system that can facilitate decision boundary control in an embodiment.

FIG. 7 is a diagram illustrating an example quantum circuit, which can send a pair of data points of different classes to different directions in an embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as quantum support vector machine algorithm code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

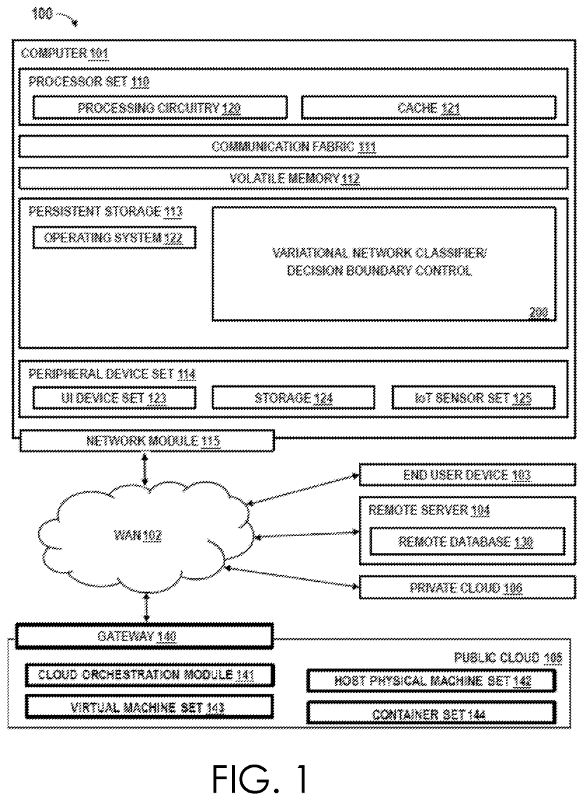

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Quantum machine learning (also referred to as QML) brings in different research elements from the intersection with classical machine learning (also referred to as ML) while leveraging the computational advantage of quantum computation. In an aspect, one or more kernel functions can be provided that can be readily expressed and computed with quantum circuits and that can be useful for modeling with different types of data. Such one or more kernel functions can also aid in providing a practical application of quantum support vector machine to different datasets.

In an aspect, a methodology can facilitate classification and/or control of decision boundaries in datasets using quantum variational circuits with a specific objective function based on the inner products of vectors representing dataset or data points. An advantage of a methodology in an embodiment is that it can force the separation of different classes to be maximal, e.g., orthogonal, based on a hyperparameter θ(theta) through an initial rearranging even when the original dataset can have narrow or smaller separation.

The implementation of the above technology may enable quantum computer to perform classification and/or determination of decision boundaries of data sets during the Noisy Intermediate Scale Quantum (NISQ) era of quantum computing. Such methodology may lead to an increase in the accuracy of resulting models built using the classification and/or determination boundaries, and may lead to an overall speed-up of the generation of these accurate models using quantum computers. Such models may eventually be used in larger artificial intelligence (AI)/machine learning (ML) algorithms, which may generally lead to a speed up of generation, and increased accuracy, in AI/ML computing systems.

In an aspect, a methodology can facilitate machine learning classification (e.g., a binary classification or multi-category classification) where through a quantum circuit the methodology can rearrange vectors representing the data into different classes (e.g., two or more classes) through a variational quantum kernel. This kernel results in grouping of the data such that within the same class they remain together and data across the classes split further apart, e.g., depending on the inner product of the two. In this way, the methodology can work without requiring labels between features. In an embodiment, a methodology can use the inner product of the two different classes to control the decision boundary. Another advantage is that the methodology can become very general (e.g., generally applicable) and independent of data or labels. Another advantage can be that the methodology can classify so called hard to classify mixed data with tighter decision boundaries and high accuracy. The methodology can be deployed across different types of databases, for example, including exceptionally difficult databases which are difficult to classically classify.

A methodology in an embodiment can facilitate classifying datasets using quantum variational circuits with an objective function based on the inner products.

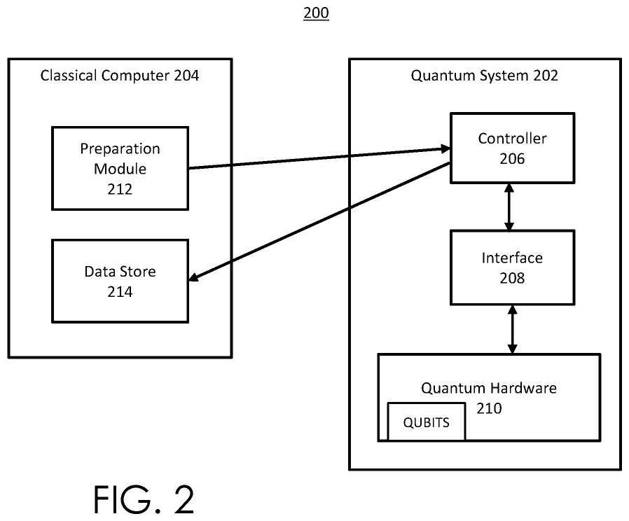

FIG. 2 is a block diagram of an example system that can provide a quantum variational network classifier and/or perform decision boundary control in an embodiment. System 200 can facilitate processing of a quantum algorithm. System 200 can be a hybrid computing system including a combination of one or more quantum computers, quantum systems, and/or classical computers. In an example shown in FIG. 2, system 200 can include a quantum system 202 and a classical computer 204. In an embodiment, quantum system 202 and classical computer 204 can be configured to be in communication via one or more of wired connections and wireless connections (e.g., a wireless network). Quantum system 202 can include a quantum chipset that includes various hardware components for processing data encoded in qubits. The quantum chipset can be a quantum computing core surrounded by an infrastructure to shield the quantum chipset from sources of electromagnetic noise, mechanical vibration, heat, and other sources of noise, which tend to degrade performance. Classical computer 204 can be electronically integrated, via any suitable wired and/or wireless electronic connection, with quantum system 202.

In the example shown in FIG. 2, quantum system 202 can be any suitable set of components capable of performing quantum operations on a physical system. A quantum operation can be, for example, a quantum gate operation that manipulate qubits to interact with one another in accordance with the quantum gate operation. In a gate-based quantum system, such quantum gate operations can implement a quantum circuit. For example, a quantum circuit can include a sequence of quantum gate operations on one or more selected qubits. In an embodiment, quantum system 202 can include a controller 206, an interface 208, and quantum hardware 210. In some embodiments, all or part of each of controller 206 (e.g., a local classical controller), interface (e.g., a classical-quantum interface) 208, and quantum hardware 210 can be located in a cryogenic environment to aid in the performance of the quantum operations. Quantum hardware 210 may be any hardware capable of using quantum states to process information. Such hardware may include a plurality of qubits and mechanisms to couple/entangle qubits in order to process information using the quantum states. A qubit can be implemented as a physical device. Examples of physical implementation of a qubit can include, but not limited to, a superconducting qubit, a trapped ion qubit, and/or others. Qubits may include, but are not limited to, charge qubits, flux qubits, phase qubits, spin qubits, and trapped ion qubits. Quantum computations can be performed by applying various quantum gates (e.g., for gate-based systems) or other operations on one or more qubits or qubit states to result in quantum states of the qubits. Quantum gates can include one or more single-qubit gates, two-qubit gates, and/or other multi-qubit gates. For example, quantum hardware 210 can be configured to perform quantum gate operations or other operations on qubits.

Controller 206 can be any combination of digital computing devices capable of performing a quantum computation, such as executing a quantum circuit which may model or specify quantum operations or quantum gate operations, in combination with interface 208. Such digital computing devices may include digital processors and memory for storing and executing quantum commands using interface 208. Additionally, such digital computing devices may include devices having communication protocols for receiving such commands and sending results of the performed quantum computations to classical computer 204. Additionally, the digital computing devices may include communications interfaces with interface 208. In an embodiment, controller 206 can be configured to receive classical instructions (e.g., from classical computer 204) and convert the classical instructions into commands (e.g., command signals) for interface 208. Command signals being provided by controller 206 to interface 208 can be, for example, digital signals indicating quantum gates or other quantum operations to apply to qubits 104 to perform a specific function (e.g., decision boundary control described herein). Interface 208 can be configured to convert these digital signals into analog signals (e.g., analog pulses such as microwave pulses) that can control the quantum hardware 210, e.g., to have one or more quantum gates or other operations act on one or more qubits to manipulate interactions between qubits.

Interface 208 can be a classical-quantum interface including a combination of devices capable of receiving commands or command signals from controller 206 and converting those commands or command signals into quantum operations for implementing on quantum hardware 210. In an embodiment, interface 208 can convert the commands from controller 206 into drive signals that can drive quantum hardware 210, e.g., manipulate qubits, e.g., control quantum gate operations on qubits. Additionally, interface 208 can be configured to convert signals received from quantum hardware 210 into digital signals capable of processing and transmitting by controller 206 (e.g., to classical computer 204). Devices included in interface 208 can include, but are not limited to, digital-to-analog converters, analog-to-digital converters, waveform generators, attenuators, amplifiers, optical fibers, lasers, and filters. Interface 208 can further include circuit components configured to measure a basis of the plurality of qubits following the implementation of quantum gates, where the measurement will yield a classical bit result. For example, a basis of |0 [symbol] corresponds to classical bit zero, and a basis of |1 [symbol] corresponds to classical bit one. Each measurement performed by interface 208 can be read out to a device, such as classical computer 204, connected to quantum system 202. A plurality of measurement results provided by interface 208 can result in a probabilistic outcome.

Classical computer 204 can include hardware components such as processors and storage devices (e.g., including memory devices and classical registers) for processing data encoded in classical bits. In one embodiment, classical computer 204 can be configured to control quantum system 202 by providing various control signals, commands, and data encoded in classical bits to quantum system 202. Further, quantum states measured by quantum system 202 can be read by classical computer 204 and classical computer 204 can store the measured quantum states as classical bits in classical registers. In an embodiment of an implementation, classical computer 204 can be any suitable combination of computer-executable hardware and/or computer-executable software capable of executing a preparation module 212 to perform quantum computations with data stored in data store 214 as part of building and implementing a machine learning protocol. Data store 214 may be a repository for data to be analyzed using a quantum computing algorithm, as well as the results of such analysis. Preparation module 212 may be a program or module capable of preparing classical data from data store 214 to be analyzed as part of the implementation of a quantum circuit. Preparation module 212 may be instantiated as part of a larger algorithm, such as a function call of an application programming interface (API) or by parsing a hybrid classical-quantum computation into aspects for quantum and classical calculation. Preparation module 212 may generate instructions for creating a quantum circuit using quantum gates. In an embodiment, such instructions may be stored by controller 206, and may instantiate the execution of the components of interface 208 so that the quantum operations of the quantum gates may be performed on quantum hardware 210.

Components of classical computer 204 are described in more detail above with reference to FIG. 1. In an example system, classical computer 204 can be a laptop computer, a desktop computer, a vehicle-integrated computer, a smart mobile device, a tablet device, and/or any other suitable classical computing device. Additionally or alternatively, classical computer 204 may also operate as part of a cloud computing service model, such as Software as a Service (SaaS), Platform as a Service (PaaS), or Infrastructure as a Service (IaaS). Classical computer 204 may also be located in a cloud computing deployment model, such as a private cloud, community cloud, public cloud, or hybrid cloud.

System 200 can implement a quantum variational network or circuit for classification and/or boundary decision control. The quantum variational network implemented by system 200 can be implemented for various applications including but not limited to support vector machines in machine learning, which can provide classification results.

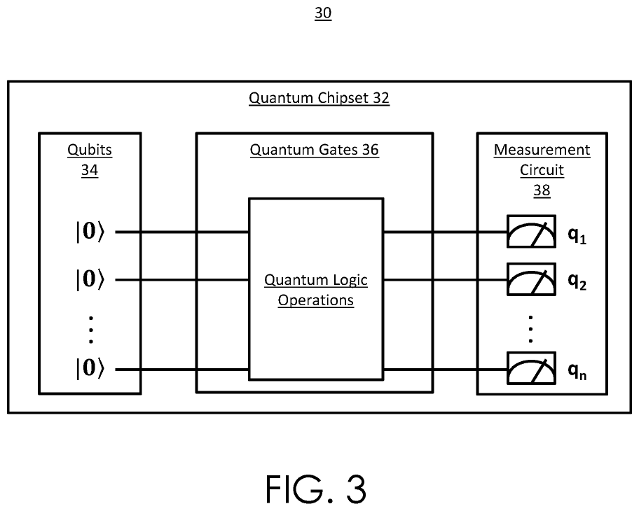

FIG. 3 illustrates a schematic of an example quantum computing system 30 that may facilitate implementing a quantum variational network for classification and/or boundary decision control in an embodiment. Quantum computing system 30 can be implemented by a quantum system shown at 202 in FIG. 2. Quantum computing system 30 can include a quantum chipset 32. Quantum chipset 32 can include one or more components configured to operate on a plurality of qubits 34. For example, a quantum circuit can be implemented by components of the quantum chipset 32. In an aspect, qubits 34 can be arranged in a two-dimensional or three-dimensional array, such as being arranged in a lattice structure. A two-dimensional qubit array can be formed on a surface of a two-dimensional wafer, and the qubits 34 can be arranged in a two-dimensional lattice structure and configured to communicate with one another. A three-dimensional device array can be formed by a stack of two-dimensional wafers, and qubits 34 can be arranged in a three-dimensional lattice structure and configured to communicate with one another via connections between the two-dimensional wafers.

Quantum chipset 32 can be a quantum computing core surrounded by an infrastructure to shield quantum chipset 32 from sources of electromagnetic noise, mechanical vibration, heat, and other sources of noise, which tend to degrade performance. Magnetic shielding can be used to shield the system components from stray magnetic fields, optical shielding can be used to shield the system components from optical noise, thermal shielding and cryogenic equipment can be used to maintain the system components at controlled temperature, etc. For example, an infrastructure that can surround quantum chipset 32 can be a refrigerator that can cool the quantum chipset to an operating temperature of quantum chipset 32.

In the figure, the plurality of qubits can be denoted as q1, q2 . . . , qn. Quantum chipset 32 can operate by performing quantum logic operations (e.g., using quantum gates 36) on qubits. Quantum gates 36 can include one or more single-qubit gates and/or two-qubit gates. Quantum circuits can be formed based on quantum gates 36, and quantum chipset 32 can operate the quantum circuits to perform quantum logic operations on single qubits or conditional quantum logic operations on multiple qubits. Conditional quantum logic can be performed in a manner that entangles the qubits. Control signals can be received by quantum chipset 32, and quantum chipset 32 can use the received control signals to manipulate the quantum states of individual qubits and the joint states of multiple qubits.

Measurement interface 38 can include circuit components configured to measure a basis of qubits 34, where the basis is a measurement that will yield a classical bit result. Each measurements performed by measurement interface circuit 38 can be read out to a device (e.g., a classical computer) connected to quantum computing system 30. A plurality of measurement results provided by measurement circuit 38 can result in a probabilistic outcome.

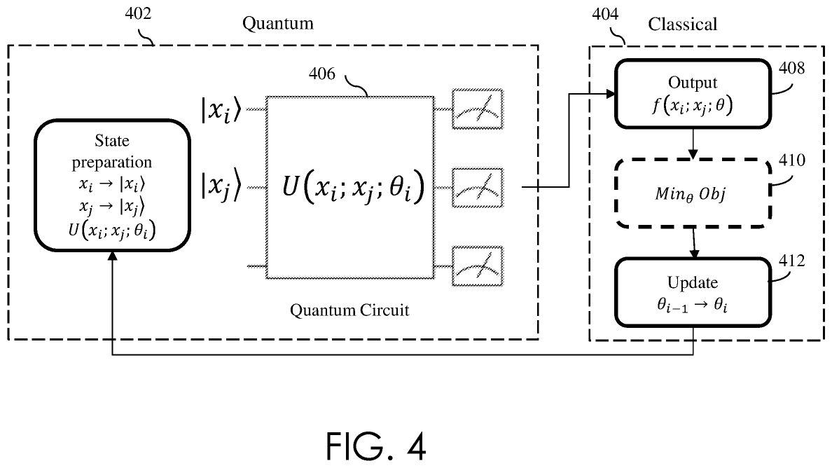

FIG. 4 is another diagram illustrating an example of a system that can provide for decision boundary control and/or quantum variation network classifier, e.g., in machine learning, in an embodiment. The system, for example, can implement a quantum variation network classifier in an embodiment. In an embodiment, the quantum variation network classifier implements the following algorithm.

For pairs of data points {xᵢ, xⱼ} in data samples (e.g., at least a plurality of data points in data samples or all pairs of data points in data samples), prepare |ψ(xᵢ, θ) [symbol] and |ψ(xⱼ, θ) [symbol] using a circuit with parameter θ, and compute the inner product Fᵢⱼ= [symbol] ψ(xᵢ, θ)∥ψ(xⱼ, θ) [symbol] . A pair of data points {xᵢ, xⱼ} can be data or vectors that represent two different classes in data samples or training dataset. For example, data point xᵢ can be of one class or category, and data point xⱼ can be of another class or category, for example, for purposes of classifying data points into classes or categories. By way of example, classification can include one class classified as cancerous cell and another class classified as non-cancerous cell, for example, in cancer detection; e.g., data points can be pixels in images, which can be classified as malignant or benign. Another example of classification can include erroneous transaction or non-erroneous transaction as two different classes, for example, in real-time online network transaction.

Data points {xᵢ, xⱼ} can be encoded as quantum states, for example, as state vectors. For example, qubit states and a parameter (e.g., rotation parameter that specifies angle of rotation) can be used as input to a quantum circuit. For instance, the data points are encoded as qubit states of qubits, where a quantum circuit operates or acts on the qubits based on the parameter (θ), resulting in qubit states or state vectors |ψ(xᵢ, θ) [symbol] and |ψ(xⱼ, θ) [symbol] . In an embodiment, the rotation angle specified by the rotation parameter may be effectuated via a rotation operator acting on a respective qubit that can be realized in quantum hardware via logical rotation operator or quantum gates. The inner product of the two state vectors can be computed, e.g., Fᵢⱼ= [symbol] ψ(xᵢ, θ)∥ψ(xⱼ, θ) [symbol] . This can be performed for a plurality of pairs of data points or all pairs of data points of different classes.

For instance, a classical system 404 can provide a quantum system 402 with a pair of data points and a parameter. This parameter can be initialized to a given value, which can be updated or changed for different iterations. The quantum system 402 may encode the data points, and using the parameter, apply quantum operations of a quantum circuit 406 on qubits representing the data points. The operations of the quantum circuit 406 transforms the input qubit states of the qubits to output qubit states. For example, transformed qubit states (e.g., state vectors) associated with the pair of data points can result. This can be done for a plurality of data points in a sample dataset or all data points in a sample dataset or training dataset such that inner products can be computed between all pairs of data points in the sample dataset.

In an embodiment, the quantum circuit 406 can be any quantum circuit 406, for example, which has a threshold or predefined expressibility to show how much or which part of area (e.g., in the Bloch sphere) can be covered by the circuit. For instance, in a gate-based system, the quantum circuit 406 can have one or more rotation gates such as Rx, Ry, Rz gates, and one or more gates capable of entangling the qubits.

In an embodiment, the quantum system 402 may compute the inner product of the transformed qubit states (e.g., state vectors), which the classical system 404 can measure and use as output 408. For example, the quantum system 402 may implement additional quantum circuit(s), which may implement inner product computation. The classical system 404 may use the inner product output 408 in finding a solution of an objective function 410. For instance, the classical system 404 may perform summations of the inner products output by the quantum system 402, and optimize the objective function 410. For example, a parameter (rotation angle, θ) that minimizes the objective function can be solved for. In an aspect, the objective function 410 defines and measures the inner product of given data in relation to a hyperparameter. In another embodiment, the classical system 404 may measure the transformed qubit states (e.g., state vectors) as output 408, and compute the inner product of the measured outputs, for use in solving an objective function 410.

The classical system 404 may update the parameter 412 and send the updated parameter to the quantum system 402, to iterate or repeat the process. The process between the classical system 404 and the quantum system 402 can iterate using different parameter (θ) values.

To find a parameter that can separate the data points of different classes in state vector space (e.g., Hilbert space), an objective function 410 defined as follows can be solved. Define objective function as, Obj=Σ_{i,j}yᵢ⊕yⱼ|Fᵢⱼ|²−α, where yᵢ, yⱼ are class indicators, e.g., where yᵢ, yⱼ∈{0, 1} are class labels associated with data points {xᵢ, xⱼ}, ⊕ represents addition modulo 2, and α can be treated as a hyperparameter. This hyperparameter (α) can be given or predetermined. For example, the hyperparameter can be configurable. In an embodiment, different values of hyperparameter (α) can be used, or tried, to select one that can be used in this objective function. This hyperparameter (α) can control the optimization or minimization, for example, how much apart the data points of different classes can be distanced apart. Min e Obj. For example, a parameter (θ) can be searched for, or determined, that minimizes this objective function. Different methods can be utilized for minimizing the objective function. One example can be a grid search, where all given or possible rotational parameter (θ) can be searched for the value that minimizes the objective function. Another approach can be a gradient descent search or gradient based search. Other approaches can include, but are not limited to, least square, trust reason based optimization.

Depending on different methods of optimization, e.g., finding parameter θ, that minimizes the objective function, the solving of the objective function can be performed iteratively as the quantum system 402 transforms the qubit states (e.g., state vectors) associated with data points for a given parameter θ. Also depending on different methods of optimization, the solving of the object function can be performed at the end of all the transformations performed by the quantum system 402. For example, in a grid search, the classical system 404 may store in a data store or a repository all inner product values associated with all different parameter (θ) output by the quantum system 402, then use the stored values to solve the objective function 410. As another example, in a gradient descent type of search for an optimal or desired parameter (θ) value, the optimization 410 (solving the objective function) may be performed iteratively as the quantum system 402 transforms the qubit states (e.g., state vectors). Other types of optimization methods can be utilized for solving the objective function.

Using the parameter (θ) that is found or determined, kernel matrix Kᵢⱼ= [symbol] ψ(xᵢ, θ)∥ψ(xⱼ, θ) [symbol] can be built. For instance, the kernel matrix includes inner products of qubits transformed using a target circuit parameter, the parameter (θ), which is found to minimize the objective function. This can be done by the classical system 404, e.g., after finding a solution to the objective function 410. For example, a matrix of sample size by sample size can be built that has inner products of a plurality of, or all pairs of data samples or training data. This matrix can represent a feature map for classification. This matrix can be used as a kernel in by a Support Vector Machine (SVM).

In an embodiment, the kernel can be used by an SVM, where the SVM performs a maximum margin optimization. For instance, the best or optimal line or hyperplane that can separate the two classes based on the largest margin from the data points of the feature map can be drawn or determined, for example, for classification. In another embodiment, the kernel can be used for Gaussian process. In an embodiment, the classical system 404 can perform such maximum margin optimization and/or Gaussian process. Briefly, SVM may perform an optimization that finds a hyperplane (or a line) that has the largest or maximum margin (e.g. maximum distance) between data points of different classes. For example, in a binary classification problem, a hyperplane can be obtained that divides data points into two groups such that the distance between the hyperplane and the nearest point from either group is maximized.

For example, in an embodiment, the feature map can represent data associated with cancer detection, for example, image pixel data that can include benign and/or malignant cells. The system described herein can improve provide hardware and technique that can improve cancer detection. As another example, the feature map can represent data associated with real-time online transactions, which for example, can include erroneous or non-erroneous transactions. The system described herein can provide hardware and technique that can improve erroneous transaction detection in online real-time transactions.

Yet in another aspect, once a parameter (θ) that minimizes the objective function 410 is found, during inference stage, any new data point can be input to a quantum circuit 404. The quantum circuit 404 acting on the qubit encoded with information associated with the new data point, can transform the qubit state to transformed qubit states (e.g., state vector) using the parameter. Based on the value of the transformed qubit states (e.g., state vector), it can be determined, in which class or classification the new data point belongs.

As described above, a system can provide a quantum variational network classifier and/or decision boundary control in an embodiment. The system can include quantum hardware including at least qubits, the quantum hardware configured to receive signals that control the qubits to transform qubit states of the qubits. Quantum hardware can be part of the quantum system 402, for example, which can apply the operations of the quantum circuit 406 on qubits. Transforming the qubit states by the quantum hardware can result in separating the pair of data points (those that are of different classes) farther apart in a state vector space.

A processor such as one shown at 404 can be configured to at least control the quantum hardware to transform the qubit states associated with a pair of data points based on a circuit parameter representing a rotation angle. Inner product of transformed qubit states associated with the pair of data points is computed. The processor can perform controlling of the quantum hardware, e.g., via the components of the quantum system 402, for at least a plurality of pairs of data points in a training dataset, and inner products can be computed for all such respective pairs of data points. The processor may retrieve the training dataset from a storage device or memory, and/or receive the training dataset from another processor locally or remotely via any one or more wired or wireless computer networks.

In an embodiment, the processor can compute the inner products based on the transformed qubit states or state vectors. In another embodiment, the quantum hardware can compute the inner products, where the quantum hardware is given additional command signals to apply additional quantum operations on the qubits (e.g., implement additional quantum circuit) to compute inner product of transformed qubit state associated with a given pair of data points.

The processor can minimize an objective function based on the inner products, where minimizing the objective function finds a target circuit parameter representing a target rotation angle that minimizes the objective function. For, or in, solving the object function, a processor can update the circuit parameter and repeat controlling of the quantum hardware described with reference to 502 above using the updated circuit parameter. In an embodiment, the target circuit parameter is a single parameter that can be applied to all data points, e.g., of all classes, in a given dataset, e.g., regardless of in which class a data point belongs.

In an embodiment, the object function includes a hyperparameter, which can provide for controlling decision boundary. For example, different values of the hyperparameter can control or tune decision boundary or boundaries. For instance, the parameter can be found via the objective function with a hyperparameter such that a processor can impart a desired angle between classification groups (e.g., two group) during the training.

A processor can build a kernel matrix based on the inner products computed for a sample dataset and the target circuit parameter passed to the quantum hardware. For example, a kernel or kernel function transforms given data or features to a different space. The kernel matrix includes transformed data points, e.g., as described above. A processor may retrieve the sample dataset from a storage device or memory, and/or receive the sample dataset from another processor locally or remotely via any one or more wired or wireless computer networks. The sample dataset can be a new dataset different from the training dataset, for example, for classification and/or decision boundary control.

In an embodiment, the sample dataset can represent pixel values of an image and the classification detects possible cancerous cells in the image. In this way, the method provides for improving cancer detection system and/or technique in an embodiment. For instance, more specifically, in an embodiment where the present system and/or method can be used for classification of cancerous cells, each data sample or dataset can correspond to pixels of an image that may contain cancerous cells in it. Such cells may comprise different colors and/or intensity, which can then correspond to differences in the pixels that may belong to cancerous cells. When analyzing such images, it may be difficult to produce an accurate boundary between healthy cells and potentially cancerous cells and/or the detection of cancerous cells may be imprecise. The present system and/or method may allow to advantageously transform points of the data sample corresponding to the pixels of an image/images into points in a Hilbert space (i.e., into qubit states) and use a kernel matrix that separates them in such a way that better highlights the potentially cancerous cells. In other words, the distance between points that correspond to pixels indicative of healthy cells and those that correspond to pixels indicative of potentially cancerous cells may be increased by this advantageous transformation. This would then make it easier to separate them and to establish thresholds on cells that would be deemed healthy versus those that may be potentially cancerous.

In another embodiment, the sample dataset can represent online real-time transactions, and the classification detects possible erroneous transactions. Erroneous transactions, for example, may present security risks in a computer environment. In this way, the method provides for improving erroneous transaction detection system and/or technique in an embodiment. For instance, more specifically, in an embodiment where the present system and/or method can be used for classification of erroneous transactions, each data sample or dataset can correspond to an on-line transaction data. When analyzing such data, it may be difficult to produce an accurate boundary between erroneous data and normal non-erroneous data and/or the detection of erroneous transaction from normal non-erroneous transaction may be imprecise. The present system and/or method may allow to advantageously transform points of the data sample corresponding to the on-line transaction data into points in a Hilbert space (i.e., into qubit states) and use a kernel matrix that separates them in such a way that better highlights the potentially erroneous transaction. In other words, the distance between points that correspond to data indicative of non-erroneous transaction and those that correspond to data indicative of potentially erroneous transaction may be increased by this advantageous transformation. This would then make it easier to separate them and to establish thresholds on on-line transaction data that would be deemed normal non-erroneous versus those that may be potentially erroneous.

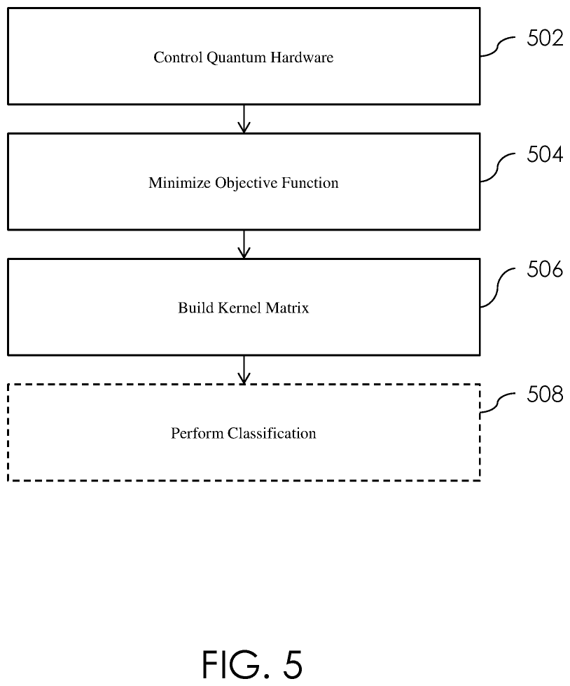

FIG. 5 is a flow diagram illustrating a method in an embodiment. The method can provide a quantum variational network and/or quantum circuit for classification and/or decision boundary control. The method can be performed by a system, for example, shown in FIG. 2. In an embodiment, a method of classification rearranges vectors representing data (e.g., feature data) into different classes (e.g., two or more classes) through a variational quantum kernel, which can be implemented through a quantum circuit. This kernel results in grouping of the data such that data within the same class remain together and data across the classes (different classes) split further apart. Such distancing can be manipulated based on the inner product of the two vectors. In an embodiment, the method uses the inner product of the two vectors to control the decision boundary. In an embodiment, the method can be generally applicable and independent of data or labels.

For example, during training, a quantum circuit is used to find a parameter for sending state vectors to certain directions. For example, given sets of two state vectors of different classes as training samples, a rotational angle can be determined, which when applied to state vectors using a quantum circuit rearranges the state vectors such that the state vectors within the same class remain together while the state vectors of different classes stay apart. By way of example, state vectors representing data of one class can be rearranged to be close to one basis, while state vectors representing data of another class can be rearranged to be another basis, such that they are close to being orthogonal.

At 502, a processor (e.g., at least one processor of one or more computer or hardware processors) can control quantum hardware to transform qubit states associated with a pair of data points (of a plurality of data points) based on a circuit parameter representing a rotation angle. For instance, qubits representing a pair of data points are passed through a quantum circuit of the quantum hardware with a circuit parameter, which specifies a rotation angle. Transforming the qubit states by the quantum hardware distances the pair of data points in different classes farther apart in a state vector space. In an embodiment, the rotation angle specified by the circuit parameter may be effectuated via a rotation operator acting on a respective qubit, which can be realized in quantum hardware via logical rotation operator or quantum gates. In an embodiment, the processor controls via quantum hardware (e.g., implementing quantum logic gates) the amount or degree of rotation of the qubits via the circuit parameter. Based on the transformed qubit states or state vectors, inner product of the transformed qubit states associated with the pair of data points can be computed.

In an embodiment, the processor can receive the inner products computed by the quantum hardware. For instance, the processor may also control the quantum hardware, via a quantum system, for example, provide commands to the quantum system, which sends control signals to the quantum hardware to operate on the qubits of the hardware to compute inner products.

In another embodiment, the processor based on the transformed qubit state or state vectors, can compute inner products. For example, the processor may receive measurements of transformed qubit states and computes the inner products using the transformed qubit states.

In an embodiment, controlling the quantum hardware to transform qubit states can be performed for a plurality of, or all pairs of data points in a training dataset, and inner products can be computed for respective plurality of, or all pairs of data points, e.g., based on the respective transformed qubit states. The processor may retrieve the training dataset from a storage device or memory, and/or receive the training dataset from another processor locally or remotely via any one or more wired or wireless computer networks.

At 504, at least one processor can minimize an objective function based on the inner products. In an embodiment, the minimizing finds a target circuit parameter representing a target rotation angle that minimizes the objective function. For, or in, solving the object function, a processor can update the circuit parameter and repeat controlling of the quantum hardware described with reference to 502 above using the updated circuit parameter. In an embodiment, the target circuit parameter is a single parameter that can be applied to all data points, e.g., of all classes, in a given dataset, e.g., regardless of in which class a data point belongs.

As described above, the objective function can be Obj=Σ_{i,j}yᵢ⊕yⱼ|Fᵢⱼ|²−α, where yᵢ, yⱼ are class indicators, e.g., where yᵢ, yⱼ∈{0, 1} are class labels associated with data points {xᵢ, xⱼ}, ⊕ represents addition modulo 2, and α can be treated as a hyperparameter. The objective function is defined in terms of a sum of inner products of transformed qubit states associated with the plurality of pairs of data points, and in relation to a hyperparameter. For example, in an embodiment, the object function includes a hyperparameter, which can provide for controlling decision boundary. The hyperparameter can be configurable. For example, different values of the hyperparameter can control or tune decision boundary or boundaries. For instance, the parameter can be found via the objective function with a hyperparameter such that a processor can impart a desired angle between classification groups (e.g., two group) during the training.

At 506, at least one processor can build a kernel matrix based on the inner products computed for a sample dataset and the target circuit parameter passed to the quantum hardware. For example, a kernel or kernel function transforms given data or features to a different space. The kernel matrix includes transformed data points, e.g., as described above. A processor may retrieve the sample dataset from a storage device or memory, and/or receive the sample dataset from another processor locally or remotely via any one or more wired or wireless computer networks. The sample dataset can be a new dataset different from the training dataset, for example, for classification and/or decision boundary control.

At 508, one or more processors may use the kernel matrix to perform a classification, i.e., classify the sample dataset, where the kernel matrix represents a feature map of the sample dataset. In an embodiment, a processor performing the classification in machine learning inference stage, need not be the same processor that performed training to find the target circuit parameter. A feature map is a function that takes feature vectors in one space and transforms them into feature vectors in another space. A feature vector can be vectorial representation of an object, for example, representing a plurality of characteristics of the object. A feature map can return a transformed form of those characteristics. By way of example, given a feature vector [volume, weight, height, width] a feature map can return [1, volume/weight, height*width], [height*width], or [volume]. Similarly, as another example, a sample dataset can contain characteristics of a number of human cell samples extracted from patients, e.g., including those who were believed to be at risk of developing cancer. Cell characteristics may differ significantly between benign and malignant samples. A feature map can transform feature vectors representing such cell characteristics, which can then be used for classification, e.g., by a support vector machine model, e.g., to provide an early indication of whether cell samples might be benign or malignant.

In an embodiment, the sample dataset can represent pixel values of an image and the classification detects possible cancerous cells in the image. In this way, the method provides for improving cancer detection system and/or technique in an embodiment. For instance, more specifically, in an embodiment where the present system and/or method can be used for classification of cancerous cells, each data sample or dataset can correspond to pixels of an image that may contain cancerous cells in it. Such cells may comprise different colors and/or intensity, which can then correspond to differences in the pixels that may belong to cancerous cells. When analyzing such images, it may be difficult to produce an accurate boundary between healthy cells and potentially cancerous cells and/or the detection of cancerous cells may be imprecise. The present system and/or method may allow to advantageously transform points of the data sample corresponding to the pixels of an image/images into points in a Hilbert space (i.e., into qubit states) and use a kernel matrix that separates them in such a way that better highlights the potentially cancerous cells. In other words, the distance between points that correspond to pixels indicative of healthy cells and those that correspond to pixels indicative of potentially cancerous cells may be increased by this advantageous transformation. This would then make it easier to separate them and to establish thresholds on cells that would be deemed healthy versus those that may be potentially cancerous.

In another embodiment, the sample dataset can represent online real-time transactions, and the classification detects possible erroneous transactions. Erroneous transactions, for example, may present security risks in a computer environment. In this way, the method provides for improving erroneous transaction detection system and/or technique in an embodiment. For instance, more specifically, in an embodiment where the present system and/or method can be used for classification of erroneous transactions, each data sample or dataset can correspond to an on-line transaction data. When analyzing such data, it may be difficult to produce an accurate boundary between erroneous data and normal non-erroneous data and/or the detection of erroneous transaction from normal non-erroneous transaction may be imprecise. The present system and/or method may allow to advantageously transform points of the data sample corresponding to the on-line transaction data into points in a Hilbert space (i.e., into qubit states) and use a kernel matrix that separates them in such a way that better highlights the potentially erroneous transaction. In other words, the distance between points that correspond to data indicative of non-erroneous transaction and those that correspond to data indicative of potentially erroneous transaction may be increased by this advantageous transformation. This would then make it easier to separate them and to establish thresholds on on-line transaction data that would be deemed normal non-erroneous versus those that may be potentially erroneous.

In an embodiment, performing a classification based on the kernel matrix, where the kernel matrix represents a feature map of the sample dataset, can include performing maximum margin optimization that finds at least one hyperplane separating features in the feature map. Briefly, maximum margin optimization finds a hyperplane that has the largest margin between groups (e.g., classes) of data points. For example, in a binary classification problem, a hyperplane can be obtained that divides data points into two groups such that the distance between the hyperplane and the nearest data point from either group is maximized. For instance, a classification algorithm such as support vector machine (SVM) finds a hyperplane that best separates the two groups and that maximizes the distance to points in either group. This distance can be referred to as the “margin” and the points that fall on the margin can be referred to as supporting vectors. To find this hyperplane, a machine learning classification algorithm such as SVM may use the kernel matrix that transforms the sample dataset, and e.g., solve a convex optimization problem that maximizes this margin with constraints that points in each group should be on the correct side of the hyperplane.

In an aspect, the method can provide a quantum variational network classifier and/or decision boundary control, where no error correction or mitigation are needed.

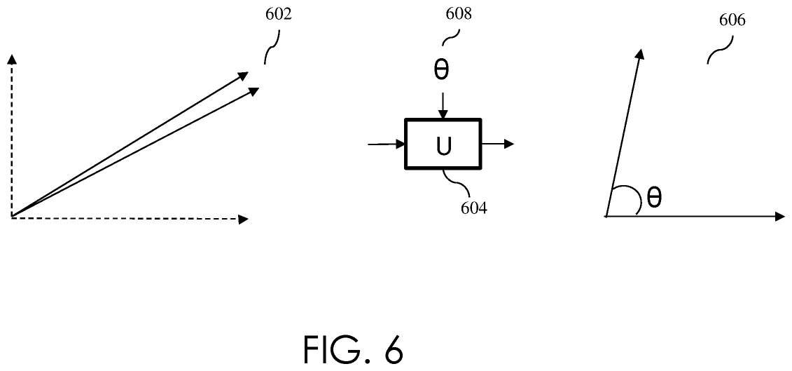

FIG. 6 is a diagram illustrating is another diagram illustrating an example of a system that can facilitate decision boundary control in an embodiment. Original pair of data points 602 can be transformed via a quantum system or quantum circuit 604 to result in a transformed pair of data points 606 (e.g., transformed state vectors or transformed qubit states in quantum system) using or based on the parameter (θ) 608.

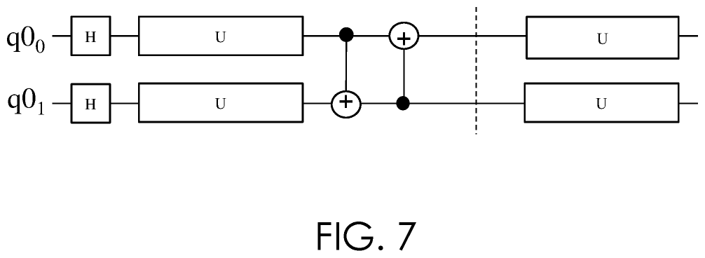

FIG. 7 is a diagram illustrating an example quantum circuit, which can send a pair of data points of different classes to different directions in an embodiment. As shown, an example quantum circuit can include two qubits and gates such as Hadamard gates and U-gates (e.g., single-qubit rotation gate with 3 Euler angles).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, run concurrently, substantially concurrently, in a partially or wholly temporally overlapping manner, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
controlling, by at least one processor, quantum hardware to transform qubit states associated with a plurality of pairs of data points in a training data set, wherein each pair of data points is transformed using a circuit parameter representing a rotation angle, wherein inner product of transformed qubit states associated with the each pair of data points is computed;
minimizing, by the at least one processor, an objective function based on the inner products, wherein the minimizing finds a target circuit parameter representing a target rotation angle that minimizes the objective function;
building, by the at least one processor, a kernel matrix based on the inner products computed for a sample dataset and the target circuit parameter passed to the quantum hardware.

2. The method of claim 1, further including performing a classification based on the kernel matrix, wherein the kernel matrix represents a feature map of the sample dataset.

3. The method of claim 2, wherein performing a classification includes performing a support vector machine algorithm using the kernel matrix.

4. The method of claim 1, wherein the objective function is defined in terms of a sum of inner products of transformed qubit states associated with the plurality of pairs of data points, and in relation to a hyperparameter.

5. The method of claim 4, wherein the hyperparameter is configurable.

6. The method of claim 1, wherein the at least one processor receives the inner products computed by the quantum hardware.

7. The method of claim 1, wherein the at least one processor receives measurement of transformed qubit states and computes the inner products using the transformed qubit states.

8. A computer program product comprising a computer readable storage medium having program instructions embodied therewith, the program instructions readable by a device to cause the device to:
control quantum hardware to transform qubit states associated with a plurality of pairs of data points in a training data set, wherein each pair of data points is transformed using a circuit parameter representing a rotation angle, wherein inner product of transformed qubit states associated with the each pair of data points is computed;
minimize an objective function based on the inner products, wherein minimizing the objective function finds a target circuit parameter representing a target rotation angle that minimizes the objective function; and
build a kernel matrix based on the inner products computed for a sample dataset and the target circuit parameter passed to the quantum hardware.

9. The computer program product of claim 8, wherein the device is further caused to perform a classification based on the kernel matrix, wherein the kernel matrix represents a feature map of the sample dataset.

10. The computer program product of claim 9, wherein the device is further caused to perform a classification by performing a support vector machine algorithm using the kernel matrix.

11. The computer program product of claim 8, wherein the objective function is defined in terms of a sum of inner products of transformed qubit states associated with the plurality of pairs of data points, and in relation to a hyperparameter.

12. The computer program product of claim 11, wherein the hyperparameter is configurable.

13. The computer program product of claim 8, wherein the device is configured to receive the inner products computed by the quantum hardware.

14. The computer program product of claim 8, wherein the device is configured to receive measurements of transformed qubit states and compute the inner products using the transformed qubit states.

15. A system comprising:
quantum hardware including at least qubits, the quantum hardware configured to receive signals that control the qubits to transform qubit states of the qubits; and
at least one processor configured to at least:
control the quantum hardware to transform the qubit states associated with a plurality of pairs of data points based on a circuit parameter representing a rotation angle, wherein inner products of transformed qubit states associated with the plurality of pairs of data points is computed;
minimize an objective function based on the inner products, wherein minimizing the objective function finds a target circuit parameter representing a target rotation angle that minimizes the objective function; and
build a kernel matrix based on the inner products computed for a sample dataset and the target circuit parameter passed to the quantum hardware.

16. The system of claim 15, wherein the processor is further configured to perform a classification based on the kernel matrix, wherein the kernel matrix represents a feature map of the sample dataset.

17. The system of claim 16, wherein performing a support vector machine algorithm using the kernel matrix to perform classification.

18. The system of claim 15, wherein the objective function is defined in terms of a sum of the inner products of transformed qubit states associated with the plurality of pairs of data points, and in relation to a hyperparameter.

19. The system of claim 18, wherein the hyperparameter is configurable.

20. The system of claim 15, wherein the sample dataset represents pixel values of an image, and the classification detects possible cancerous cells in the image.
